(19) United States
(12) Patent Application Publication
(10) Pub. No.: US 2026/0221081 A1
(43) Pub. Date: Jul. 30, 2026

(54) DISPLAY WITH INTEGRATED USER MONITORING SYSTEM

(71) Applicant: DESIGN LED PRODUCTS LIMITED, Livingston (GB)

(72) Inventors: James GOURLAY, Livingston (GB); Stéphane ROBINET, Livingston (GB); Derek PEDEN, Livingston (GB); Marius JANKAUSKAS, Livingston (GB); Berkan ABACI, Livingston (GB); Yves LE FOULER, Livingston (GB); Sara EL YAHYAOUI, Livingston (GB); Charlie DEMBREY, Livingston (GB)

(21) Appl. No.: 19/324,709

(22) Filed: Sep. 10, 2025

(30) Foreign Application Priority Data
Nov. 11, 2024 (GB) GB2416560.7

(51) Int. Cl. G09G 3/32; G02B 3/00

(52) U.S. Cl. CPC G09G 3/32; G02B 3/00

(57) ABSTRACT

A display system with an embedded user monitoring system is disclosed herein. The display system is suitable for use with a vehicle. The display comprises a backlighting tile with one or more apertures. The display system further comprises one or more optical sensors and or one or more infrared LEDs. The infrared LEDs are located within the one or more apertures. The display system advantageously is more aesthetically pleasing than systems known in the art and provides improved operation of the user monitoring system functionality.

This application claims priority to the Nov. 11, 2024 filing date of Great Britain Patent Application No. GB2416560.7, the contents of which are incorporated herein by reference.

The present invention relates to the field of display systems. In particular, the present invention relates to a display system with an integrated user monitoring system. The display system is suitable for, although not necessarily exclusively, the interior and or exterior of a vehicle, for example, as a display system integrated in the instrumental panel of a vehicle, or as a display system integrated in the outside of a B pilar of a vehicle.

### BACKGROUND TO THE INVENTION

A user monitoring system known in the art, for example an interior monitoring system, is a safety system for a vehicle which monitors a driver and occupants, specifically driver characteristics such as distraction, drowsiness, alertness and or tiredness. It can be used also for identifying the identity of user. Such systems known in the art comprise at least an infrared LED and an optical sensor both located within a housing. Interior monitoring systems are positioned within the interior of a vehicle, for example on a dashboard, steering column or interior rear-view mirror. The infrared LED emits infrared radiation (typically with a wavelength of 940 nm) towards the driver and or occupants, which is reflected off for example the driver and or occupants' faces and reflected infrared radiation is collected by the optical sensor thereby resulting in an image of the driver and or occupants. If the interior monitoring system detects, for example, the driver is not paying attention to the road, the interior monitoring system provides an output, such as illuminating warning lights or even actively braking the vehicle.

User monitoring systems known in the art are located within dedicated housing which disadvantageously clutter the interior of a vehicle and negatively impact the aesthetics of the vehicle. Furthermore, as the components of user monitoring systems known in the art are constrained within the dedicated housing, they are relatively close together which is not desirable for optimal thermal performance of such systems. These systems also disadvantageously comprise a relatively poor signal-to-noise ratio and so have limited accuracy. Furthermore, such systems can be prone to disturbance due to a high amount of background infrared radiation emitted by infrared LED light source.

There is generally a need for an apparatus to address the problems identified above.

### SUMMARY OF INVENTION

It is an object of an aspect of the present invention to provide an apparatus that obviates or mitigates one or more drawbacks or disadvantages of the prior art.

Further aims and objects of the invention will become apparent from reading the following description.

According to a first aspect of the present invention there is provided a display system, suitable for a vehicle, the display system comprising:
a backlighting tile comprising one or more apertures;
one or more optical sensors; and
one or more infrared LEDs,
wherein the one or more infrared LEDs are located within the one or more apertures.

Most preferably the one or more optical sensors are also located within the one or more apertures. The one or more optical sensors may comprise one or more infrared sensors and or one or more visible sensors.

Optionally, the one or more infrared LEDs and the one or more optical sensors may be located within the same one or more apertures.

It is advantageous for the one or more infrared LEDs and or one or more optical sensors to be located in the one or more apertures in the backlighting tile as this results in a relatively thinner display system. Furthermore, a thinner display system is easier to integrate into a support, for example, into the interior or the exterior of a vehicle. Also, a user monitoring system can be integrated in a display system as presented in this invention more easily while keeping unnoticed by a user.

Most preferably, the display system comprises two or more infrared LEDs. Preferably, the two or more LEDs are located within one or more apertures. Most preferably, the two or more LEDs are located within two or more apertures.

It is advantageous for the display system to comprise two or more infrared LEDs, specifically a distributed array of two or more infrared LEDs, as this results in a wider field of illumination and a wider field of view. This increases the signal-to-noise ratio, and thereby the quality of the resulting detected image. The infrared LEDs can be operated at lower power resulting in greater longevity and reduced power consumption.

Preferably, the one or more apertures comprises one or more sensor apertures and or one or more LED apertures.

Preferably, the one or more optical sensors are located within the one or more sensor apertures.

Preferably, the one or more infrared LEDs are located within the one or more LED apertures.

Preferably, each of the one or more LED apertures comprises one of the one or more infrared LEDs.

Preferably, the display system further comprises a decorative layer. The backlighting tile is configured to backlight the decorative layer.

Preferably, the decorative layer may comprise one or more layers translucent to visible light. The decorative layer may comprise a smoke print layer.

Preferably, the display system further comprises a cover layer. The decorative layer is located between the cover layer and the backlighting tile.

Preferably, the display system further comprises one or more infrared covers. Each infrared cover may be positioned between the cover layer and the one or more infrared LEDs.

Preferably, the one or more infrared covers comprises one or more sensor infrared covers and or one or more LED infrared covers. The one or more sensor infrared covers are positioned between the cover layer and the one or more optical sensors. The one or more LED infrared covers are positioned between the cover layer and the one or more infrared LEDs.

Optionally, the display system may further comprise a mask print layer and or a diffuser layer. The mask print layer and or the diffuser layer may be located between the decorative layer and the backlighting tile.

Optionally, the one or more infrared covers maybe recessed into the diffuser layer.

Optionally, the display system may further comprise a reflector layer. The reflector layer may be located on the opposing side of the backlighting tile relative to the location of the decorative layer.

Optionally, the display system may further comprise one or more optical lenses. The one or more optical lenses are configured to focus radiation upon the one or more optical sensors. The one or more optical lenses may be configured to focus infrared radiation on the one or more infrared sensors and or visible radiation on the one or more visible sensors.

Optionally, the backlighting tile may comprise an RGB LED light tile. In an embodiment, the backlighting tile may comprise a lightguide and one or more RGB LEDs. The one or more RGB LEDs may be side mounted to the lightguide or encapsulated in the lightguide.

Optionally, the one or more apertures may extend between opposing surfaces of the backlighting tile.

Optionally, the one or more apertures within the backlighting tile may extend into one or more additional layers of the display system. The one or more apertures within the backlighting tile may extend into the reflector layer and or the diffuser layer.

Preferably, the display system is located within the interior of the vehicle. Advantageously, the user monitoring system of the display system can monitor the occupants of the vehicle.

Alternatively, the display system may be located external to the vehicle. Advantageously, the display system, and specifically the user monitoring system being external to the vehicle, may facilitate extending human machine interface. For example, externally locating the display system may facilitates: customisation of the vehicle interior or exterior prior to opening vehicle doors; and or activating the profile of driver seat personalisation; and or in opening both rear doors and trunk (also termed the car boot) may indicate the presence of at least one adult with a small child and pram.

### BRIEF DESCRIPTION OF DRAWINGS

There will now be described, by way of example only, various embodiments of the invention with reference to the drawings, of which:

FIG. 1 presents an expanded perspective view of a display system in accordance with an embodiment of the present invention;

FIG. 2 presents a cross-sectional schematic view of the display system of FIG. 1;

FIG. 3A presents a plan view of an alternative embodiment of the display system of FIG. 1 in operation depicting emitted infrared radiation from one infrared LED;

FIG. 3B presents a plan view of the alternative embodiment of the display system in FIG. 3A in operation depicting presented the resulting reflected infrared radiation;

FIG. 4A presents a plan view of the display system of FIG. 1 in operation depicting emitted infrared radiation from three infrared LEDs; and

FIG. 4B presents a plan view of the display system of FIG. 1 in operation depicting the resulting reflected infrared radiation.

In the description which follows, like parts are marked throughout the specification and drawings with the same reference numerals. The drawings are not necessarily to scale and the proportions of certain parts have been exaggerated to better illustrate details and features of embodiments of the invention.

### DETAILED DESCRIPTION OF THE PREFERRED EMBODIMENTS

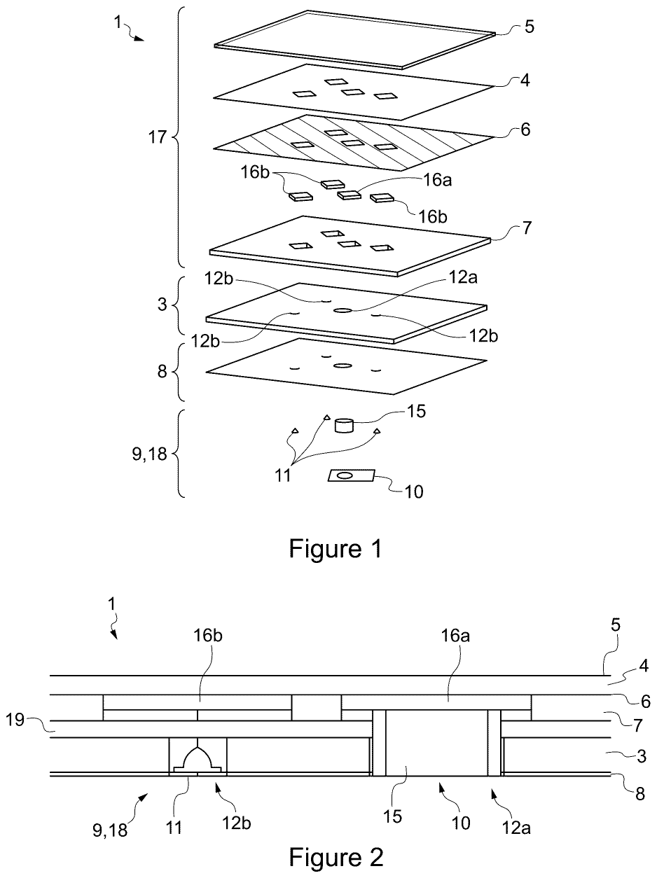

Embodiments of the present invention will now be described with reference to FIGS. 1 to 4.

FIGS. 1 and 2 depict a display system 1 suitable for a vehicle. Particularly, the display system 1 is suitable for use as trim within the interior of a vehicle positioned on a dashboard near a driver 1. Alternatively, or additionally, the display system 1 may be positioned near other occupants of the vehicle or even on the exterior of the vehicle. As can be seen, the display system 1 comprises various layers as will now be described. 1 Display System

The display system 1 comprises a backlighting tile 2. The backlighting tile 2 may take the form of a RGB LED light tile. Alternatively, backlighting tile 2 may take the form of a lightguide with a plurality of side mounted RGB LEDs or an array of RGB LEDs distributed across the backlighting tile 2. It will be appreciated that the backlighting tile 2 may take further alternative forms known in the art.

The display system 1 further comprises a decorative layer which takes the form of a smoke print layer 3. The backlighting tile 2 is configured to backlight the smoke print layer 3. It will be appreciated that the decorative layer could take alternative forms such as a display, Thin Film Transistor (TFT) and or Organic Light-Emitting Diode (OLED).

The display system 1 further comprises a cover layer 4. The smoke print layer 3 is located between the cover layer 4 and the backlighting tile 2. The cover layer 4 is an outermost layer of the display system 1 and, in use within a vehicle, the cover layer 4 is exposed to the interior of the vehicle. A purpose of the cover layer 4 is to protect the underlying layers within the display system 1 from the surrounding environment. As such, the cover layer 4 takes the form of a glass material for properties comprising high strength, high scratch resistance, desirable thermal performance and high chemical resistance as well as being transparent to visible light and infrared radiation. It will be appreciated that the cover layer 4 may comprise alternative materials with equivalent properties to glass.

The display system 1 further comprises a mask print layer 5 and a diffuser layer 6 both of which are located between the smoke print layer 3 and the backlighting tile 2. The diffuser layer 6 scatters visible light from the backlighting tile 2 such that, in use, the smoke print layer 3 is more uniformly illuminated with visible light. The mask print layer 5 protects and obscures from view the underlaying layers and or components.

The display system 1 further comprises a reflective layer 7, located on an opposing side of the backlighting tile 2 relative to the location of the smoke print layer 3. The reflective layer 7 reflects visible light originating from the backlighting tile 2 towards the smoke print layer 3. The reflective layer 7 reduces the loss of visible light.

A key feature of the present invention is that the display system 1 comprises an integrated user monitoring system 8. The display system 1 comprises an optical sensor in the form of an infrared sensor 9 and three infrared LEDs 10. It will be appreciated that the optical sensor may comprise infrared and or visible light sensors.

The backlighting tile 2 comprises four apertures 11. The infrared sensor 9 and the infrared LEDs 10 are each located within one of the four apertures 11 as can be seen in FIGS. 1 and 2.

In operation, the infrared LEDs 10 emit infrared radiation 12 which passes through the layers of the display system 1, exiting the cover layer 4 and into the surrounding environment, such as an interior of a vehicle. The infrared radiation 12 bounces off surfaces within the surrounding environment, such as a driver 1, and reflected infrared radiation 13 passes back through the display system 1 and is detected by the infrared sensor 9.

The display system 1 depicted in FIGS. 1 and 2 further comprises an optical lens 14 located upon the infrared sensor 9. The optical lens 14 is configured to capture and or focus reflected infrared radiation 13 upon the infrared sensor 9. The combination of an infrared sensor and optical lens is termed and infrared camera.

The four apertures 11 extend between opposing surfaces (alternatively termed opposite sides) of the backlighting tile 2. In other words, the four apertures extend through the entire thickness from a “top” surface to a “bottom” surface of the backlighting tile. Furthermore, it can be seen that the apertures 11 extend into other layers of the display system 1, namely the reflective layer 7, the diffuser layer 6, the mask print layer 5 and the smoke print layer 3.

With reference to FIG. 1, the four apertures 11 comprise one sensor aperture 11a and three LED apertures 11b. The infrared sensor 9 is located within the sensor aperture 11a. Each of the three infrared LEDs 10 are located within an LED aperture 11b.

The display system 1 further comprises four infrared covers 15. The four infrared covers 15 are located, specifically recessed, within the diffuser layer 6 and aligned with the apertures 11. In other words, the four infrared covers 15 are located over and cover the infrared sensor 9, the three infrared LEDs 10 and the optical lens 14.

Specifically, the four infrared covers 15 comprise one sensor infrared cover 15a and three LED infrared covers 15b. The sensor infrared cover 15a is positioned between the cover layer 4 and the infrared sensor 9. Each of the three LED infrared covers 15b are positioned between the cover layer 4 and one of the three infrared LEDs 10.

The infrared covers 15 are configured to be transparent to infrared radiation such that the infrared radiation 12 emitted from the infrared LEDs and reflected infrared radiation 13 can pass through the infrared covers 15 without scattering. This is important to construct an accurate image of, for example, a driver's face. The infrared covers 15 are configured to scatter visible light, thereby increasing the uniformity of the visible light backlighting functionality of the display system 1. As such, the infrared covers 15 assist in masking that embedded within the display system 1 are the infrared sensor 9, the three infrareds LEDs 10 and the optical lens 14. The infrared covers 15 remove or at least minimise any defects in the visible light backlighting functionality of the display system 1. The diffuser layer 6 does not extend across the apertures 11 as this layer may scatter infrared radiation as well as visible light.

With particular reference to FIG. 1, the layers and components of the display system 1 may be grouped as follows. The combination of the cover layer 4, smoke print layer 3, mask print layer 5, infrared covers 15 and diffuser layer 6 is termed the optical stack 16. The combination of the infrared sensor 9, the three infrared LEDs 10 and the optical lens 14 is termed the infrared components 17. Furthermore, with particular reference to FIG. 2, it can be seen that the display system 1 comprises an air gap 18 between the layers.

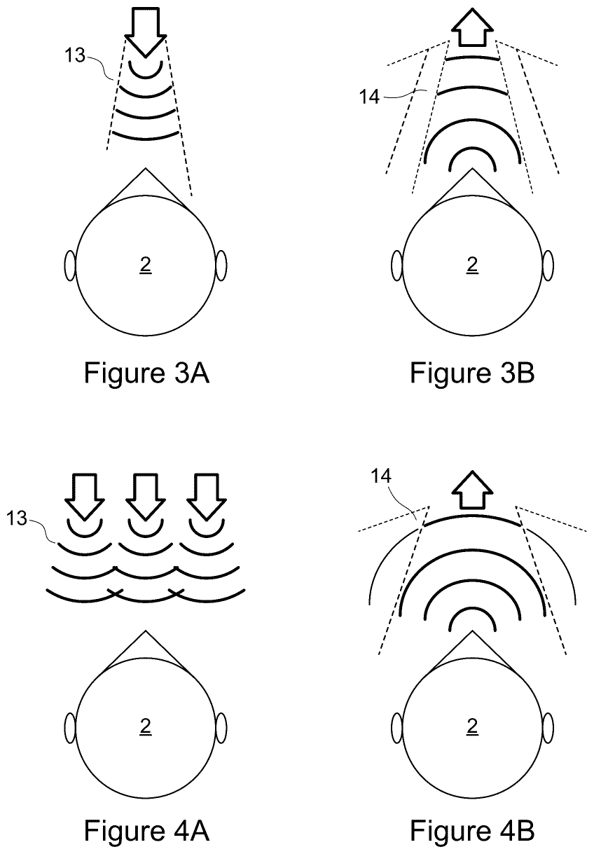

It will be appreciated that the embedded user monitoring system 8 of the display system 1 can operate one infrared LED 10. However, it is advantageous to have an array of infrared LEDs 10, such as three infrared LEDs 10 as now discussed in the context of FIGS. 3 and 4.

FIGS. 3 and 4 both depict a plan view of a driver 1 with (A) infrared radiation 12 emitted from the display system 1 towards the driver 1 and (B) reflected infrared radiation 13 reflected off the driver 1 back towards the display system 1.

FIGS. 3A and 3B depict the emitted and reflected infrared radiation 12, 13 from a display system 1 comprising one infrared LED 10. As can be seen from FIG. 3A there is a relatively narrow field of illumination (FOI) upon the driver 1 and the resulting image field of view (FOV) depicted in FIG. 3B is also relatively narrow. In contrast, FIGS. 4A and 4B depict the emitted and reflected infrared radiation 12, 13 from a display system 1 comprising three infrared LEDs 10. FIG. 4A depicts a combined, distributed, larger FOI upon the driver 1. FIG. 4B depicts the resulting larger image FOV. As such, it is advantageous for the display system 1 to comprise multiple infrared LEDs 10 as this increases the signal-to-noise ratio, and thereby the quality of the resulting image detected by the infrared sensor 9.

It will be appreciated that the display system 1 may comprise any number of infrared sensors 9, any number of infrared LEDs 10 and any number of apertures 11 in which the infrared sensors 9 and or infrared LEDs 10 are located.

Furthermore, it will be appreciated the distribution the infrared sensors 9 and or the infrared LEDs 10 within the apertures 11 may not be one infrared sensor 9 or one infrared LED 10 per aperture 11 as depicted in FIGS. 1 and 2. There may be multiple infrared sensors 9 and or infrared LEDs 10 within an aperture 11 or even none. The apertures 11 have been subcategorised as sensor apertures 11a or LED apertures 11b to aid the description of FIGS. 1 and 2 but this terminology does not limit these apertures to exclusively comprising an infrared sensor 9 or infrared LED 11b.

It will also be appreciated that the dimensions of the apertures 11 may vary. For example, as can be seen in FIG. 2, the sensor aperture 11a is large than the LED aperture 11b so as accommodate the infrared sensor 9 which is larger than the infrared LEDs 10. Furthermore, the cross-sectional size and or shape of the aperture may change.

It will be appreciated that in alternative embodiments the display system 1 may optionally comprise additional layers and or structures to that described herein. These additional layers and or structures may be to, for example, optimise the thermal performance of the display system 1 or enhances the aesthetics of the display system 1.

It will be appreciated that the integrated user monitoring system 8 of the display system 1 may be operated such that the infrared LEDs 10 are only illuminated when there is minimal visible radiation. For example, during the daytime, there is no need to use the infrared LEDs 10 as the visible sensors will capture reflected visible radiation.

The display system 1 disclosed herein advantageously provides an improved user monitoring system 8, particularly with improved eye tracking and an improved signal to noise ratio.

A key advantage associated with the one infrared LEDs and infrared sensors being located within apertures is that the display system being relatively thin.

In an embodiment of the present invention that comprises multiple infrared LEDs 10, this is advantageous as this increases the signal-to-noise ratio, and thereby the quality, of the resulting image detected by the infrared sensor 9. Furthermore, multiple infrared LEDs 10 are advantageous in the context of sun immunity, namely the disturbance of the user monitoring system 8 due to a high amount of background infrared radiation, for example from sun light. In addition, for the same infrared irradiance of the driver 1, each infrared LED 10 of a display system 1 comprising multiple infrared LEDs 10 can be operated at a relatively reduced electrical load thereby increasing the lifetime of the infrared LEDs 10. This results in power savings and so reduced CO₂ emissions.

Incorporating the user monitoring system 8, specifically the infrared components 17, within a display system 1 advantageously provides improved thermal performance relative to systems known in the art. Instead of the infrared components 17 constrained within a dedicated housing and in close proximity, the infrared components 17 can be spaced further apart and distributed across the display system 1. A key advantageous feature is that the infrared sensor 9 is integrated such that it is not negatively influenced by the light or heat from the infrared LEDs 10 or visible light from the surrounding environment.

More generally, embedding the user monitoring system 8 within a display system 1 is more aesthetically pleasing. This arrangement avoids the need for an aesthetically cumbersome dedicated housing. The infrared components 17 and associated electrical wiring are concealed within the display system 1.

The present invention relates to the integration of array of infrared LEDs in a segmented low-resolution LED display, with the LED circuit enabling electrical and thermal integration and display segmentation providing optical isolation to the infrared camera. For the same infrared irradiance of the driver, each infrared LED in the array operates a lower current, with resulting power and CO₂ savings, and reducing operational load on each infrared LED.

A display system with an embedded user monitoring system is disclosed herein. The display system is suitable for use with a vehicle. The display comprises a backlighting tile with one or more apertures. The display system further comprises one or more optical sensors and or one or more infrared LEDs. The infrared LEDs are located within the one or more apertures. The display system advantageously is more aesthetically pleasing than systems known in the art and provides improved operation of the user monitoring system functionality.

Throughout the specification, unless the context demands otherwise, the terms “comprise” or “include”, or variations such as “comprises” or “comprising”, “includes” or “including” will be understood to imply the inclusion of a stated integer or group of integers, but not the exclusion of any other integer or group of integers. Furthermore, unless the context clearly demands otherwise, the term “or” will be interpreted as being inclusive not exclusive.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1. A display system, suitable for a vehicle, the display system comprising:
a backlighting tile comprising one or more apertures;
one or more optical sensors; and
one or more infrared LEDs,
wherein the one or more infrared LEDs are located within the one or more apertures.

2. The display system as claimed in claim 1 wherein the one or more optical sensors are also located within the one or more apertures.

3. The display system as claimed in claim 1 wherein the display further comprises a decorative layer and wherein the backlighting tile is configured to backlight the decorative layer.

4. The display system as claimed in claim 3 wherein the display system further comprises a cover layer and wherein the decorative layer is located between the cover layer and the backlighting tile.

5. The display system as claimed in claim 4 wherein the display further comprises one or more infrared covers, each infrared cover being positioned between the cover layer and the one or more infrared LEDs.

6. The display system as claimed in claim 4 wherein the display system further comprises a reflector layer that is located on the opposing side of the backlighting tile relative to the location of the decorative layer.

7. The display system as claimed in claim 1 wherein the display system further comprises a mask print layer and or a diffuser layer and or a reflector layer.

8. The display system as claimed in claim 1 wherein the display system further comprises one or more optical lenses and wherein the one or more optical lenses are configured to focus radiation upon the one or more optical sensors.

9. The display system as claimed in claim 1 wherein the one or more apertures extend between opposing surfaces of the backlighting tile.

10. The display system as claimed in claim 9 wherein the apertures additionally extend into one or more additional layers of the display system.
